(19) United States
(12) Patent Application Publication
(10) Pub. No.: US 2016/0070009 A1
(43) Pub. Date: Mar. 10, 2016

(54) DEVICE FOR PROCESSING SIGNALS DETECTED BY NEUTRON DETECTORS AND ASSOCIATED CONTROL/COMMAND DEVICE

(71) Applicant: COMMISSARIAT À L'ÉNERGIE ATOMIQUE ET AUX ÉNERGIES ALTERNATIVES, Paris (FR)

(72) Inventors: Mounir BAKKALI, Meudon (FR); Romain COULON, Chaulgnes (FR); Stephane NORMAND, Isigny le Buat (FR)

(73) Assignee: Commissariat a l'energie atomique et aux energies alternatives, Paris (FR)

(21) Appl. No.: 14/783,335

(22) PCT Filed: Mar. 31, 2014
(86) PCT No.: PCT/EP2014/056452

§ 371 Date: Oct. 8, 2015

(30) Foreign Application Priority Data
Apr. 9, 2013 (FR) 13 53197

(51) Int. Cl. G01T 3/00; G21C 7/36

(52) U.S. Cl. CPC G01T 3/00; G21C 7/36

(57) ABSTRACT

A device for processing signals detected by a set of n neutron detectors, the device including: n switches each including an input and an output, each switch receiving, on its input, a detected signal coming from a different detector, outputs of the n switches being linked to each other; and a clock generator including a clock circuit and a sequential counter controlled by the clock circuit and configured to deliver a plurality of pulse series, each pulse series of the plurality of pulse series constituting a control signal of a different switch, the pulses of any two pulse series of the plurality of pulse series being disjointed.

### TECHNICAL FIELD AND PRIOR ART

The invention relates to a device for processing signals detected by neutron detectors and the associated device for controlling/commanding the nuclear reactor core.

Controlling and protecting the core of a civilian electricity-generating nuclear reactor are presently ensured by the use of multi-section neutron detectors providing a continuous signal that covers the height of the core in order to measure the neutron flux and the axial distribution of the power emitted by the reactor core. Each neutron detector supplies a detection signal which is transmitted to the control/command room.

The electric system which transmits the detection signals to the control/command room is made of a plurality of wires (there are as many wires as detectors). Such a system has a complex structure and its maintenance is often difficult to implement. It is an expansive system. Besides, the quality of certain electric links may not be excellent due to a poor impedance matching of certain connections. Detected signals can then be partially reflected.

The transmitting system of the invention does not have these drawbacks.

### DISCLOSURE OF THE INVENTION

Indeed, the invention relates to a device for processing signals detected by a set of n neutron detectors, the device comprising:

n switches each having an input and an output, each switch receiving, on its input, a detected signal coming from a different detector, the outputs of the n switches being linked to each other, and

a clock generator which comprises a clock circuit and a sequential counter controlled by the clock circuit and able to simultaneously deliver a plurality of pulse series, each pulse series of the plurality of pulse series constituting the control signal of a different switch, the pulses of any two pulse series of the plurality of pulse series being temporally disjointed.

According to a further feature of the invention, the device for processing signals has means for widening the width of pulses of at least one first pulse series relative to the width of pulses of at least one second pulse series.

According to another further feature of the invention, the device for processing signals further comprises means for electrically insulating the switches against a high supply DC voltage of the neutron detectors. This feature of the invention is implemented in the case where the high supply DC voltage of the neutron detectors is present where the detection signal is taken off.

The invention also relates to a device for controlling/commanding a nuclear reactor core which comprises a plurality of neutron detectors and a device for processing signals according to the invention.

According to a further feature of the invention, the neutron detectors are fission chambers.

### BRIEF DESCRIPTION OF THE FIGURES

Further features and advantages of the invention will appear upon reading a preferential embodiment made with reference to the appended figures among which:

FIG. 1 represents the schematic diagram of an exemplary control/command device which comprises a system for transmitting detection signals according to the invention;

FIG. 2 represents the schematic diagram of an exemplary system for transmitting detection signals according to the invention;

FIGS. 3A-3D represent clock signals associated with the transmitting system of FIG. 2;

FIGS. 4 and 5 illustrate two different operating modes of an exemplary system for transmitting detection signals of the invention.

In all the figures, the same reference numerals refer to the same elements.

### DETAILED DISCLOSURE OF PARTICULAR EMBODIMENTS OF THE INVENTION

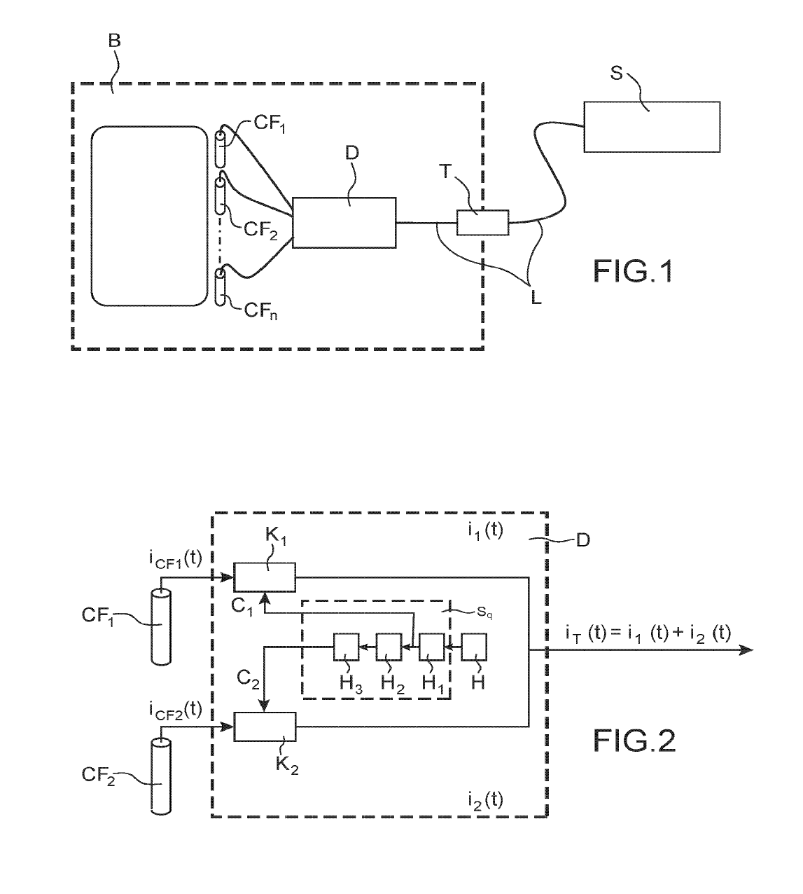

FIG. 1 represents the schematic diagram of an exemplary control/command device which comprises a device for processing detection signals of the invention.

The control/command device comprises a set of n fission chambers CFᵢ (i=1, 2, . . . , n) which deliver detection signals and a device for processing signals D which serializes the detection signals delivered by the fission chambers. The fission chambers CFᵢ (i=1, 2, . . . , n) are placed along the reactor core 1. The reactor core 1, the fission chambers CFᵢ (i=1, 2, . . . , n) and the processing device D are placed in a building B. A transmission line L and an electrical penetration T enable the signal delivered by the processing device D to be extracted from the building B.

According to the embodiment of the invention represented in FIG. 1, the neutron detectors of the control/command device are fission chambers. According to other embodiments of the invention, the neutron detectors are, for example, boron-lined ionization chambers which are compensated for gamma rays or not, boron-lined proportional counters, etc.

FIG. 2 represents the schematic diagram of an exemplary device for processing detection signals of the invention.

In the example of FIG. 2, the processing device D comprises two analog switches Kᵢ (i=1, 2), a clock circuit H and a sequential counter Sq. More generally, the processing device D of the invention comprises n analog switches.

Each analog switch Kᵢ receives on its input the current i_{CFi}(t) delivered to the fission chamber CFᵢ. The sequential counter Sq comprises three cascade clock circuits H₁, H₂, H₃. The clock circuit H preferentially operates autonomously in an astable configuration. The clock signal delivered by the clock circuit H controls the clock circuit H₁ of the sequential counter. The clock signal C₁ delivered by the clock circuit H₁ controls the clock circuit H₂ of the sequential counter and constitutes the control signal of the switch K₁. The clock signal delivered by the clock circuit H₂ controls the clock circuit H₃ which delivers a clock signal constituting the control signal C₂ of the switch K₂. In a manner known per se, the frequency and the duty cycle of the clock signals delivered by the clock circuits H₁, H₂, H₃ can be adjusted using components.

In order to properly separate in time the control pulses of the switches, the clock signal delivered by the clock circuit H₂ is not used as a control signal. More generally, in the case where the sequential counter Sq comprises n clock circuits, the clock signals delivered by the sequence of clock circuits Hₖ (k=2, 4, 6, . . . , n+(n−2)) are not used to constitute switch control signals.

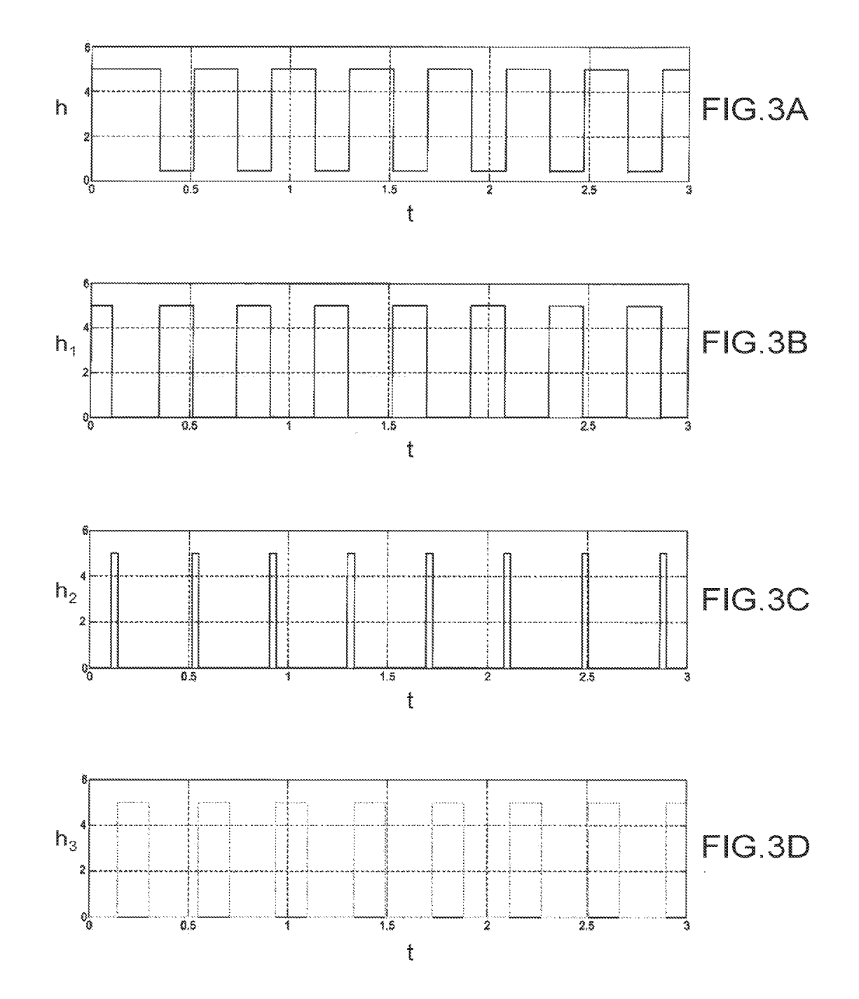

By way of non-limiting example, FIG. 3A represents the clock signal h delivered by the clock circuit H and the FIGS. 3B, 3C, 3D respectively represent the clock signals h₁, h₂, h₃ delivered by the respective clock circuits H₁, H₂, H₃. The clock signal h₂ is not used as a switch control signal. The clock signals h₁ and h₃ constitute control signals C₁ and C₂ of the respective switches K₁ and K₂.

The sequential counter operates so that the trailing edge of the pulse which controls the clock circuit Hᵢ (i=1, 2, 3) triggers the leading edge of the clock signal which is delivered by the clock circuit Hᵢ₊₁. The high level duration of the signal delivered by the clock circuit H₂ enables the low level duration between the output of the clock circuit H₁ and the output of the clock circuit H₃ to be defined. The frequency as well as the duty cycle of the input signal of the sequential counter are defined such that the low level duration is identical between signal C₂ and signal C₁ and between signal C₁ and signal C₂.

Each analog switch Kᵢ (i=1, 2) receives on its input the current i_{CFi}(t) delivered by the fission chamber CFᵢ and delivers a split current iᵢ(t) at the rate of the control signal Cᵢ. The different currents iᵢ(t) are gathered at the output of the processing device D to form a total current i_{T}(t) which is the sum of the currents iᵢ(t).

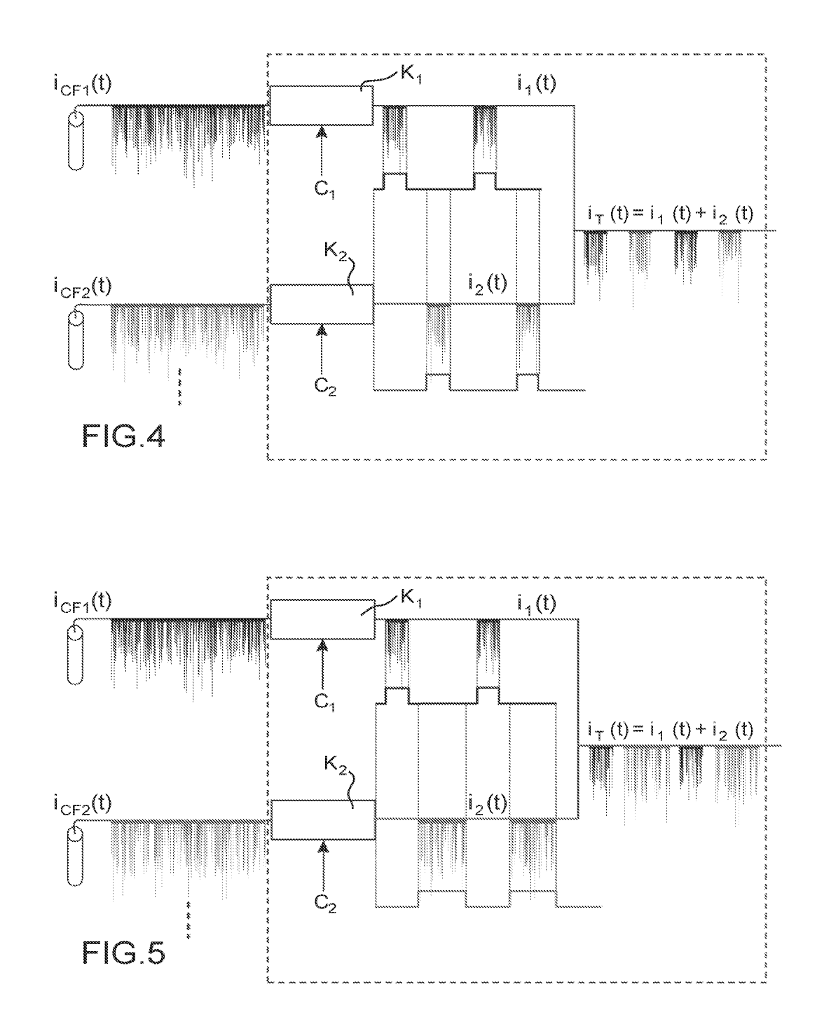

FIGS. 4 and 5 illustrate two different operating modes of a system for transmitting detection signals of the invention made of, by way of non-limiting example, two transmission channels.

In the first operating mode (see FIG. 4), the control signals C₁ and C₂ are respectively made of two pulse series having the same frequency and the same width. A pulse which takes part in the pulse series which constitutes the control signal C₁ is situated, in time, equidistant to two successive pulses which constitute the signal C₂ and vice-versa. According to this first embodiment of the invention, it is not possible to distinguish, among the current pulses i_{T}(t), the current pulses i₁(t) from the current pulses i₂(t). When an operating failure appears on only one of both fission chambers, the control/command device enables the appearance of the failure to be identified, but it is not possible to identify the fission chamber having the failure.

Advantageously, according to another operating mode of the invention (see FIG. 5), the width of the current pulses i₁(t) is adjusted to be different from the width of the current pulses i₂(t). According to the chosen example, the width of the current pulses i₂(t) is adjusted greater than the width of the current pulses i₁(t). This can be achieved by a sensible choice of the clock signals which constitute the control signals of switches K₁ and K₂. A time for selecting currents delivered by the different fission chambers is then defined to be different from one fission chamber to the other.

The current i_{T}(t) made of currents i₁(t) and i₂(t) is then digitized. Digitizing the current i_{T}(t) results in obtaining a different number of digital samples for each fission chamber. It is thus possible to identify the fission chambers. As soon as a failure appears on a fission chamber, it is then possible to identify the chamber affected by this failure.

1-5. (canceled)

6. A device for processing signals detected by a set of n neutron detectors, the device comprising:
n switches each including an input and an output, each switch receiving, on its input, a detected signal coming from a different detector, outputs of the n switches being linked to each other; and
a clock generator including a clock circuit and a sequential counter controlled by the clock circuit and configured to deliver a plurality of pulse series, each pulse series of the plurality of pulse series constituting a control signal of a different switch, the pulses of any two pulse series of the plurality of pulse series being disjointed.

7. The device according to claim 6, further comprising means for widening the width of pulses of at least one first pulse series relative to the width of pulses of at least one second pulse series.

8. The device according to claim 6, further comprising means for insulating the switches against a high supply DC voltage of the neutron detectors.

9. A device for controlling/commanding a nuclear reactor core which includes a plurality of neutron detectors, comprising a device for processing the detected signals according to claim 6.

10. A device for controlling/commanding a nuclear reactor core which includes a plurality of neutron detectors, comprising a device for processing the detected signals according to claim 7.

11. A device for controlling/commanding a nuclear reactor core which includes a plurality of neutron detectors, comprising a device for processing the detected signals according to claim 8.

12. The device for controlling/commanding a reactor core according to claim 9, wherein the neutron detectors are fission chambers.

13. The device for controlling/commanding a reactor core according to claim 10, wherein the neutron detectors are fission chambers.

14. The device for controlling/commanding a reactor core according to claim 11, wherein the neutron detectors are fission chambers.
